(19) United States
(12) Patent Application Publication
(10) Pub. No.: US 2007/0053281 A1
(43) Pub. Date: Mar. 8, 2007

(54) Method system and receiver for receiving a multi-carrier transmission

(75) Inventor: Ludwig Schwoerer, Hattingen (DE)

Correspondence Address: BANNER & WITCOFF, 1001 G STREET N W, SUITE 1100, WASHINGTON, DC, 20001, US

(73) Assignee: NOKIA CORPORATION, ESPOO (FR)

(21) Appl. No.: 10/574,350

(22) PCT Filed: Oct. 3, 2003
(86) PCT No.: PCT/FI03/00720

§ 371 Date: Apr. 3, 2006

(51) Int. Cl. H04J 11/00

(52) U.S. Cl. 370/208

(57) ABSTRACT

Mobile handheld terminals receiving DVB transmission require relatively low power consumption and TDM based transmission can be used to reduce power of the terminals. In order find pilot carrier position at least one symbol is accessed which is adapted to establish a correspondence pattern for pilot carriers in a matrix of the symbols. Carriers of the symbol are power accumulation summed within the matrix for determining a power accumulation sum maximum for indicating a pilot carrier position.

### TECHNICAL FIELD OF THE INVENTION

The present invention relates to a receiver, a mobile terminal, a sub-assembly, a chipset, a method, and a computer program for receiving a multi-carrier transmission.

### BACKGROUND ART

Services used in mobile handheld terminals require relatively low bandwidth. Estimated maximum bitrate for streaming video using advanced compression like MPEG-4 is in order of a few hundred kilobits per second.

A DVB-T (Terrestrial Digital Video Broadcasting) transmission system usually provides data rates of 10 Mbps or more. This provides a possibility to significantly reduce the average DVB-T receiver power consumption by introducing a schema which can be based on time division multiplexing (TDM). The introduced scheme can be called a time slicing.

An idea of time-slicing is to send data in bursts using significantly high bandwidth at once. This enables a receiver to stay active only a fragment of the time, while receiving bursts of a requested service. An example of the time slicing can be depicted in FIG. 1. So the original possibly streaming data can be sent as burst with high bandwidth load. Two time slice bursts (100,101) are depicted each burst having their respective synchronization portion (102) and data portion carrying the service (103).

The received data can be buffered. For example, if an applicable constant lower bitrate is required by the mobile handheld terminal, this may be provided by buffering the received bursts. Thus the data used by the end-application can be applied even as a stream by unpacking data in the buffer(s).

For an exemplary burst size of 2 Mbit and a DVB-T bitrate of 15 Mbps, the burst duration is 146 ms. If the constant bitrate (the bitrate at which the burst is read out of the buffer) is 350 kbps (e.g. one streaming service with high quality video), the average time between bursts is 6.1 s.

As the total on-time is the addition of the synchronization time plus the burst duration, synchronization times of the handheld receiver must be rigorously minimized in order to better exploit the potential of time-slicing.

So the technical use of TDM based system such as time slicing to cut power consumption to a reasonable number is generalizing for a DVB handheld environment. Therefore, in order to better exploit the potential power reduction, synchronization times of such a receiver should be decreased. A faster synchronization is desirable.

An approach for a multi-carrier transmission synchronization according to the prior art, will hereinafter be described.

Typical DVB-T Synchronization According to Prior Art

A typical DVB-T synchronization scheme until Channel Estimation is sketched a in a standardization publication: “Digital Video Broadcasting (DVB)”, ETS 300 744, chapter 4.4 incorporated herein as a reference. This typical synchronization scheme is depicted in FIG. 2. After start-up, the first step of synchronization is a Pre-FFT (Fast Fourier Transform) synchronization (200). As all metrics at this stage are derived from a guard interval correlation, a typical synchronization time of two OFDM (Orthogonal Frequency Division Multiplex) symbols is inherent.

For Subsequent Post-FFT synchronization (201), taking into account, that the first OFDM symbol is available for Post-FFT synchronization after the latency of the FFT (typically 3 OFDM symbols) a typical synchronization time of 4-5 OFDM symbols is related to this phase.

After carrier and timing synchronization have been achieved, the position of scattered pilots within an OFDM symbol has to be determined before the channel estimation can be started. As the scattered pilot position is directly related to the OFDM symbol number within the OFDM frame, no dedicated scattered pilot synchronization is typically included in prior art DVB-T receivers, but the anyhow available TPS-bit-based OFDM frame synchronization (202) instead. As a consequence, this implies a variable minimum synchronization time of 17 to 68 OFDM symbols. For DVB-H (DVB in handheld mobile terminal environment) time-slicing purposes this means the receiver must prepare for the later one, thus 68 OFDM symbols synchronization time have to be reserved. All in all, this accounts for 75 OFDM symbols synchronization time until Channel Estimation (CHE, 203) can be started. Assuming 8 k mode, this translates into 69-84 ms depending on the length of the guard interval. Taking only this part of the synchronization time (Channel Estimation omitted), already this 84 ms is quite impressive compared to 146 ms burst duration. 37% of the total on-time is just for this part of the synchronization, most of it resulting from the TPS (Transmission Parameter Signalling) synchronization (202).

In view of various limitation of the synchronization into a multi-carrier transmission, it would be desirable to avoid or mitigate these and other problems associated with prior art. Thus, there is a need for fast synchronization.

### SUMMARY OF THE INVENTION

Now a receiver, a mobile terminal, a sub-assembly, a chipset, a method, a system and a computer program have been invented to generally fast synchronize into multi-carrier transmission or a portion of it.

In accordance with aspects of the invention, there is provided a receiver, a terminal, sub-assembly of a terminal, and a method for receiving a multi-carrier transmission, wherein the multi-carrier transmission comprises various symbols, each symbol comprising a plurality of carriers, comprising:

means and respective operations for accessing at least one symbol which is adapted to establish a distinguishable power based pattern for pilot carriers in the at least one symbol,

means and respective operations for establishing power accumulation sums for possible pilot carriers of the symbol based on the pattern, and

means and respective operations for determining a power accumulation sum maximum of the sums indicating a pilot carrier position.

Some embodiments of the invention can find the position of scattered pilots within an OFDM symbol fast.

Various embodiments of the invention propose to use a power based fast scattered pilot synchronization to cut down the time needed for scattered pilot synchronization even to a minimum of only one symbol such as only one OFDM symbol. The various embodiments utilize the predetermined scattered raster pilots positioning in the symbol, in that scattered pilot carriers are boosted in higher amplitude compared to data carriers.

By sensing all possible scattered pilot raster positions with a power accumulation, the current location of the scattered pilots can be found.

In various embodiments, a synchronization can be based on realizing, that certain identifiable carriers such as scattered pilot carriers can be found at the same standardised positions (i.e. the same carrier index) within the symbol. Moreover, the certain identifiable carriers such as scattered pilot carriers can be found at the certain standardised positions (i.e. having the certain carrier index) in every standardised symbol. This may be seen, for example, from the diagonal offset pattern for pilots in some illustrations. The pilot carriers are boosted with higher magnitude, while other carriers such as data carriers are not. By sensing possible raster positions of the pilot carriers with a power accumulation, a clear distinct power sum magnitude maximum can be found for the current pilot carrier position. A certain symbol can be identified based on the pilot carrier position.

Various embodiments of the invention give a very fast way of obtaining the identifier(s) for certain symbol number in the multi-carrier transmission stream. This suffices to proceed with the further channel estimation and synchronization process. As an overall result, the whole synchronization phase of the receiver can be quite dramatically reduced. In the various embodiments this is advantageous for mobile receivers, which are operating in TDM based power saving mode. Moreover, various embodiments of the invention are quite robust to Doppler frequency based interference.

In various embodiments of the invention, synchronization time (i.e. time until the Channel Estimation) can be significantly reduced. Various embodiments may work under many relevant channel conditions making the embodiments feasible. In some embodiments, robustness of the process can be improved by cumulated power based fast scattered pilot synchronization.

In the various further embodiments, the cumulated power sums can be defined for, for example, consecutive symbols. Thereby, however, maintaining the speed of the process and providing more robustness. Of course any other symbol than the neighbouring can be selected as well.

Thus, the various embodiments of the invention can safely substitute the prior art TPS based OFDM synchronization. Also the complexity needed for the various embodiments of the invention can be relatively low since most of the required computational resources are anyhow available at the post FFT-acquisition resources, and therefore applicable. However, the post FFT-acquisition computational resources are not mandatory implementations. For example, a more specific design can be applied as well, or other used circuitry of the receiver applied.

For better understanding of the present invention, together with other and further objects thereof, reference is made to the following description, taken in conjunction with the accompanying drawings, and its scope will be pointed in the appending claims.

### BRIEF DESCRIPTION OF THE DRAWINGS

The invention will now be described, by way of example only, with reference to the accompanying drawings, in which:

FIG. 1 depicts an example of the time slicing concept according to prior art,

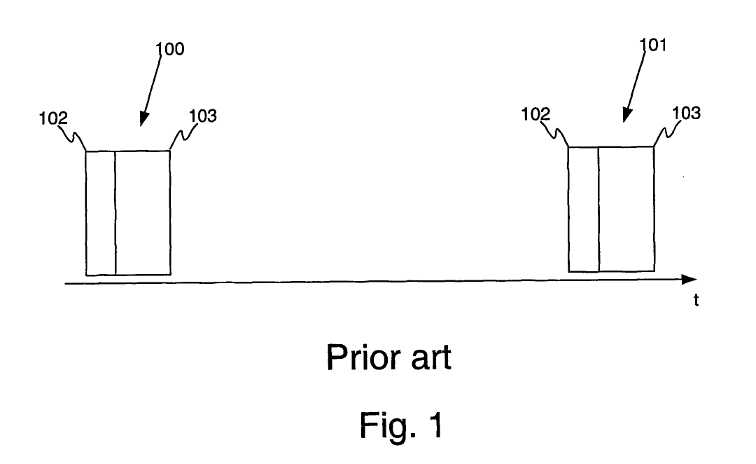

FIG. 2 depicts an example of DVB-T synchronization sequence according to prior art,

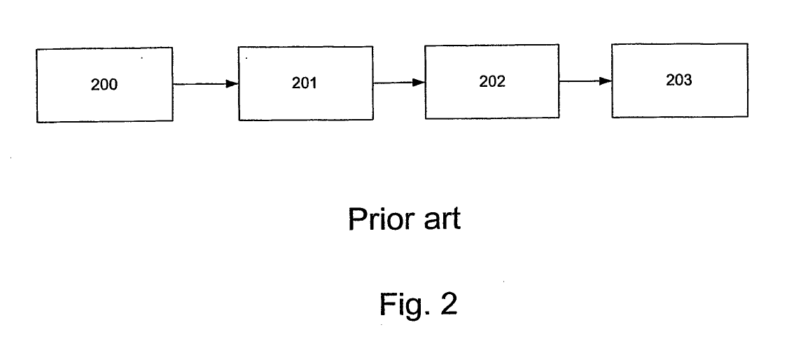

FIG. 3 depicts a partial functional block diagram for a receiver for a receiving a signal in accordance with some embodiments of the invention,

FIG. 4 depicts a partial functional block diagram for a receiver for a receiving a signal in accordance with some embodiments of the invention,

FIG. 5 depicts a partial functional block diagram for a receiver for a receiving a signal in accordance with still another embodiments of the invention,

FIG. 6 depicts a schematic example of scattered pilot positions where carrier power sums are adapted to be applied in accordance with some embodiments of the invention,

FIG. 7 depicts a schematic example of scattered pilot positions where cumulated carrier power sums are adapted to be applied in accordance with some embodiments of the invention,

FIG. 8 depicts a partial functional block diagram of a receiver for receiving a transmission in accordance with some embodiments of the invention,

FIG. 9 depicts a partial functional block diagram of a receiver for receiving a transmission in accordance with some embodiments of the invention,

FIG. 10 depicts a general simplified block diagram of a receiver for receiving a transmission in accordance with embodiments of the invention,

FIG. 11 depicts a general architecture of the system where some principles of the embodiments of the invention can be applied.

### DETAILED DESCRIPTION OF THE EMBODIMENTS

Thus the following description of the various embodiments, reference is made to the accompanying drawings which form a part hereof, and in which are shown by way of illustration various embodiments in which the invention may be practiced. It is to be understood that other embodiments may be utilized and structural and functional modifications may be made thereto without departing from the scope of the present invention.

Multi-Carrier Signal Receiving and Power Based Fast Scattered Pilot Synchronization

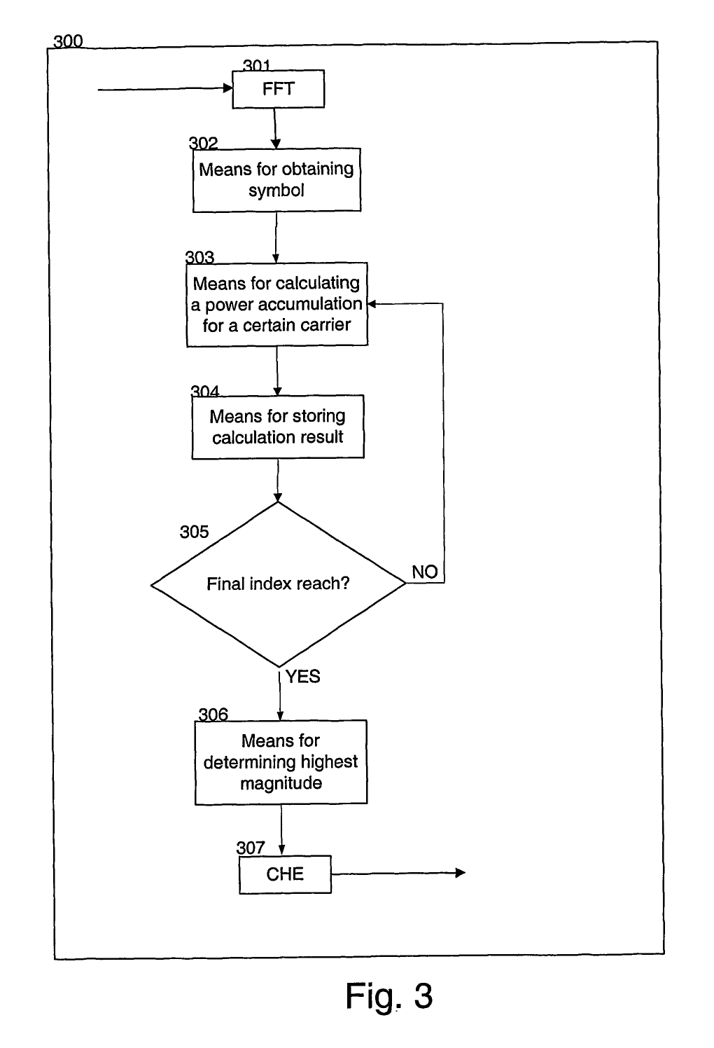

FIG. 3 depicts a partial functional block diagram for a receiver 300 for a receiving a signal in accordance with some embodiments of the invention. In FIG. 3 some portions of the receiver 300 are depicted comprising functional blocks therein, and for the sake of clarity some other parts of the receiver are omitted. The functional block may be adapted to perform the corresponding method of the receiver. The receiver 300 comprises means for receiving a multi-carrier transmission (not shown) and means for performing a Fast Fourier Transform (FFT) for the received signal in the block 301.

Various embodiments of the invention apply a method and corresponding means for receiving a multi-carrier signal such as OFDM signal. In various embodiments, this is advantageous since the multi-carrier transmission has awoken great deal of interest. The multi-carrier transmission can have a certain scattered raster pilot positions scheme. The multi-carrier such as the OFDM signal can be used in DVB. Further the multi-carrier signal is applicable in other systems as well such as mobile phone technology, other digital television systems such as e.g. ISDB (Integrated Services Digital Broadcasting) and in DAB (Digital Audio Broadcasting). In still some cases the multi-carrier transmission, e.g. OFDM, is embodied in mobile DVB or in IP over mobile DVB environment. The embodied mobile DVB environment can be referred to as DVB-H (DVB handheld) or earlier sometimes DVB-X also. The multi-carrier transmission is received at the receiver. Because of the power saving aspects, the time-slicing concept is applied for saving the power of the receiver, which can be a mobile one. In the time slicing, the transmission takes place in form of bursts. Correspondingly the receiver can receive and by the means adapt to possibly certain bursts. The synchronization into bursts should be generally fast. Some embodiments of the invention are related to the scattered pilot scheme of DVB-T/DVB-H. The same principle may also be applied to similar pilot schemes.

In some receivers and receiving methods applying some embodiments of the invention, during synchronization of the receiver the symbol number (e.g. in OFDM: 0 to 67) has to be found. For every symbol number, the position of the scattered pilots is defined. Scattered Pilots are used for Channel Estimation and Fine-Timing. Therefore, these operations can only be started after the position of the scattered pilots is known. So during synchronization of the receiver, the position of the scattered pilots within the symbols should be determined in order to start the channel estimation. The receiver comprises means for determining the position of the scattered pilots within the symbol.

Thus, in various embodiments of the multi-carrier signal reception, after carrier and timing synchronization have been achieved, the position of scattered pilots within an OFDM symbol has to be determined before the channel estimation can be started. As the scattered pilot position is directly related to the OFDM symbol number within the OFDM frame, no dedicated scattered pilot synchronization is typically included in standard DVB-T receivers.

Referring back to the examples of FIG. 3, after the FFT of means 301, the receiver comprises means for obtaining a symbol in the block 302.

In various embodiments of multi-carrier transmission systems, transmitters, and transmission methods, the symbols are transmitted in a certain predetermined sequenced manner, typically based on standards. Various embodiments of the invention relate to method and means for receiving the symbols and how to process them. The symbol can be received and saved. The symbols are transmitted continuously so that a received symbol relates to a certain point in time and another point in time relates to another symbol.

In various embodiments of the invention present a method and means to determine the scattered pilot position with a fixed synchronization time of OFDM symbol. It should be noted that even only one symbol can be applied. Therefore, the synchronization time is very fast.

Thus, the embodiments allow to proceed with channel estimation and subsequent tasks while OFDM frame synchronization may still be pursued.

For example in some embodiments by checking all possible scattered pilot raster positions with a power accumulation, the current location of the scattered pilots can be found. In some further embodiments some of the possible scattered pilot raster positions can be applied based on the predetermined pattern of the occurrence of pilots, and the invention is not limited to exhaustive amount of possible pilots.

Referring back to the FIG. 3, the receiver comprises means 303 for calculating a power accumulation for a certain carrier of the symbol.

The selection of the candidate carrier within the symbol can be based on the distinguishing pattern for pilot carriers of the symbol. The possible carrier can also be referred to when indicating the applied carrier. Thus the candidate indicates the applied carrier and the possible carrier indicates the pilot or vice versa. For example, the carrier can be selected as a candidate for possible pilot carrier position. The selection can be based on the likely position of the pilot derived from the appearance pattern of the pilots in certain amount of symbols.

Various embodiments of the invention propose a power based fast scattered pilot synchronization to cut down the time needed for scattered pilot synchronization even up to minimum of one symbol. Various embodiments utilize the fact, that scattered pilots are boosted in higher amplitude compared to data carriers. The position of the scattered pilots within the symbol can be based on a certain predetermined pattern. The positioning of the scattered pilots within the symbol can vary from one symbol to another. However, the variation between, for example, two consecutive symbol is predetermined. For example, the scattered pilots are searched for in the typical diagonal offset structure.

Referring back to the FIG. 3, the receiver comprises means 304 for storing the calculation result. The result of the means 303 can be stored therein. In one embodiment of the invention the storing means 304, where the result can be stored is accumulating means such as an accumulator which may alternatively referred to as a power accumulator.

In some embodiments there is one accumulator for each possible scattered pilot position (e.g. four in the present DVB-T/DVB-H). It should be noted that the stored result can be something else depending on the appearance pattern of the pilots. So, the power sum result can be added to only that one of these, to which the tested carrier belongs to in the embodiments.

Referring back to the examples of FIG. 3, the receiver comprises means 305 for testing whether the final or ending power sum index such as Kₘₐₓ has been reached. So an operation loop is established when the blocks 303, 304, and 305 are adapted to run and the calculation process can be performed until certain ending index is reached. If it is not, a next power sum for certain different carriers is adapted to be calculated according to the means 303 and 304. In various embodiments, the ending power sum index and the number of the power sums are selected in such a way that a certain predetermined known correspondence pattern is used for pilot carriers (positions) in a matrix comprising carriers of this symbol. Thus the amount of power sums and the number of the last power sum can be based on the known correspondence pattern for pilot carriers (positions) in the matrix having carriers of the one symbol.

Various embodiments are based on the idea, that scattered pilots of the multi-carrier signal can be found at the certain same positions (at certain carrier indexes) within the symbol. For example, certain carrier indexes can indicate the position of the pilot carrier. An interval between the pilots is known. Also the pilot carrier repetition pattern in a symbol can repeat after certain amount of symbols, for example every fourth symbol. So certain symbols have similar pilot carrier position pattern. Moreover, in the other symbols the positioning of the pilot carriers has similar pattern but the starting point can be different. So the pilots are situated in different positions compared to the neighbouring symbols but the positioning of the pilots within the symbol is still certain predetermined. These scattered pilots are boosted with higher amplitude than data carriers in the symbol.

In some further embodiments, power accumulation sums for a certain carriers (pair) can be calculated. The result is stored into a memory. A condition of a ending carrier index is being checked. For example, the maximum K-mode index id is adapted to be checked by the receiver. If the ending carrier index is not reached, the calculation and the storing is continued. For example, numerical values of the various carriers of the symbol are processed. If the ending index is reached, the memory is processed. Accordingly based on power accumulation metrics, certain amount of final power accumulations are calculated. Final power accumulations can be calculated in such a way that certain power accumulation sums (sometime referred to as pairs) are summed. The power accumulation result having the maximum, selected from the final power accumulations, shows the pilot carrier position.

Referring back to the example of FIG. 3, the receiver comprises means 306 for determining a highest magnitude maximum from the calculated power accumulation sums. A distinguishable power sum magnitude maximum can be found for the power accumulation sum indicating the current scattered raster pilot position. The determination of the highest magnitude by the means 306 is performed for the power sums(s) calculated in the means 303, 304 and 305.

Thus by detecting or checking all possible scattered pilot raster positions with a power accumulation, a distinguishable magnitude maximum is found indicating the current location of the scattered raster pilot positions.

For example, the certain substantially similar scattered pilot raster position is periodical in OFDM symbol. The same raster pilots pattern within a symbol is repeated e.g. every fourth OFDM symbol in some multi-carrier systems and methods. The symbols therebetween have certain known pilot position pattern wherein the five OFDM symbols establish a known pattern for pilot carriers. By checking the four possible scattered pilots (or positions) within a symbol, the current scattered pilot raster position is determined by the highest magnitude out of these four.

Referring back to the FIG. 3, the receiver comprises also means 307 for the channel estimation CHE.

Some embodiments of the invention give a significantly fast way of obtaining the two Least Significant Bits (LSBs) of the OFDM symbol number in a DVB-T/DVB-H data stream. The two LSBs suffice to proceed with the further channel estimation and synchronization process.

In various embodiments, as an overall result, the time for the whole synchronization phase of the receiver is dramatically reduced. This is especially important for DVB-H receivers, especially when they are operating in time-slice mode and in which the power saving is of great importance. Thus variedly embodied synchronization techniques such as the power based fast scattered pilot synchronization can speed up the synchronization time of a DVB-T/H receiver drastically. For example, for a DVB-H receiver working in time-slicing mode, this gives an important reduction in power consumption. The power based fast scattered pilot synchronization can be substituted for the TPS based OFDM frame synchronization. The possibility of using the time-slicing can be better exploited as the synchronization times of the receiver is significantly minimized.

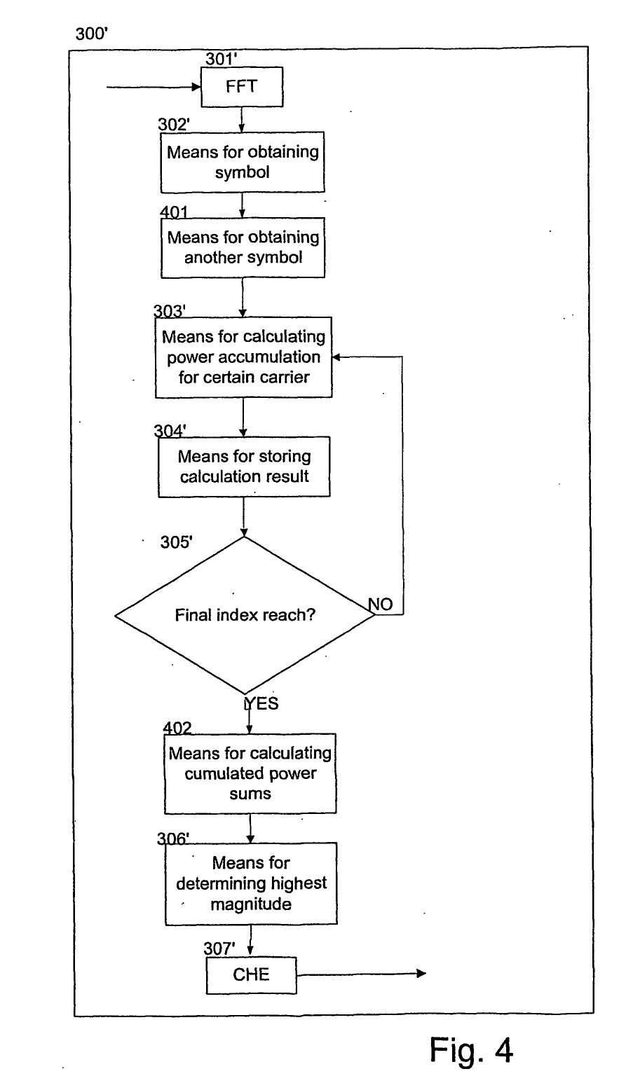

FIG. 4 depicts a partial functional block diagram for a receiver (300′) for a receiving a signal in accordance with some embodiments of the invention. In FIG. 4 some portions of the receiver 300′ are depicted comprising functional blocks therein, and for the sake of clarity some other parts of the receiver are omitted. The functional blocks may be adapted to perform the corresponding method of the receiver. The receiver 300′ can be adapted to perform the functions and means referred to in the FIG. 3. The receiver comprises means for receiving a multi-carrier transmission and means for performing the FFT for the received signal in the block 301′. The receiver further comprises means 302′ for obtaining a symbol such as the OFDM symbol. The receiver comprises also means 401 for obtaining or receiving another symbol.

As described in various embodiments of the multi-carrier transmission systems, transmitters or transmission methods, the symbols are transmitted in a certain predetermined sequenced manner, typically based on standard. Various embodiments of the invention relate to method and means for receiving the symbols and how to process them. The symbol can be received and saved. The symbols are transmitted continuously so that a received symbol relates to a certain point in time and another point in time relates to another symbol.

In some further embodiments of the invention consecutive symbols can be applied. In some embodiments of the invention two consecutive symbols are applied. However, the accessed or selected symbols can be also selected differently. So the accessed or selected symbols can be other than consecutive, and there can be selected more than two symbols for still further improving the robustness.

Thus the noise robustness can be improved in these embodiments. The consecutive symbols can of course be set to be the current and previous symbols or the current and following symbols depending on the embodiment. The scattered pilots (or scattered raster pilot positions) of consecutive OFDM symbols can be searched for detecting the scattered raster pilot position. So the scattered raster pilot position can further identify a certain symbol of the transmission/reception.

Still in some further embodiments of the invention other symbol pair than a pair of neighbouring symbols can be used. Also the robustness can be further increased by using more than two symbols, for example, a plurality of symbols. The processing time may be longer in these cases.

Referring back to the FIG. 4, the receiver comprises means 303′ for calculating power accumulation for certain carrier (pairs) within a symbol, means (304′) for storing the calculation result, and means 305′ for determining whether the ending index has been reached. So an operation loop is established when the blocks 303, 304, and 305 are adapted to run and the calculation process can be performed for candidate carriers of the symbol. For example, after the first symbol is processed the another symbol is similarly processed. For another example, four possible scattered raster pilot positions are processed within a symbol and four possible scattered raster pilot position are processed in the another symbol.

The receiver of FIG. 4 comprises also means 402 for calculating cumulated power sums (CPSs). Thus for, for example, improving robustness, also positions for scattered raster pilots of more than one symbol can be possibly searched and obtained. The cumulated power sum uses a power accumulation sum of the first symbol and a power accumulation sum of the another symbol. The selection of the power accumulation sums for the cumulated power accumulation sum can be such that the correspondence pattern of the pilot carriers is utilised. So the selection of the power sum in question is made in accordance with the appearance of the pilots within the two symbols. Thus the pilot carriers in different symbols do have a match for indicating a higher power accumulation. For example, the scattered raster pilot carriers are searched for and utilized based on their typical ‘diagonal’ offset structure.

The receiver of FIG. 4 comprises also means 306′ for determining the highest magnitude maximum from the cumulated power sums. The highest one determines the current scattered raster pilot position. The receiver comprises also the CHE means 307′.

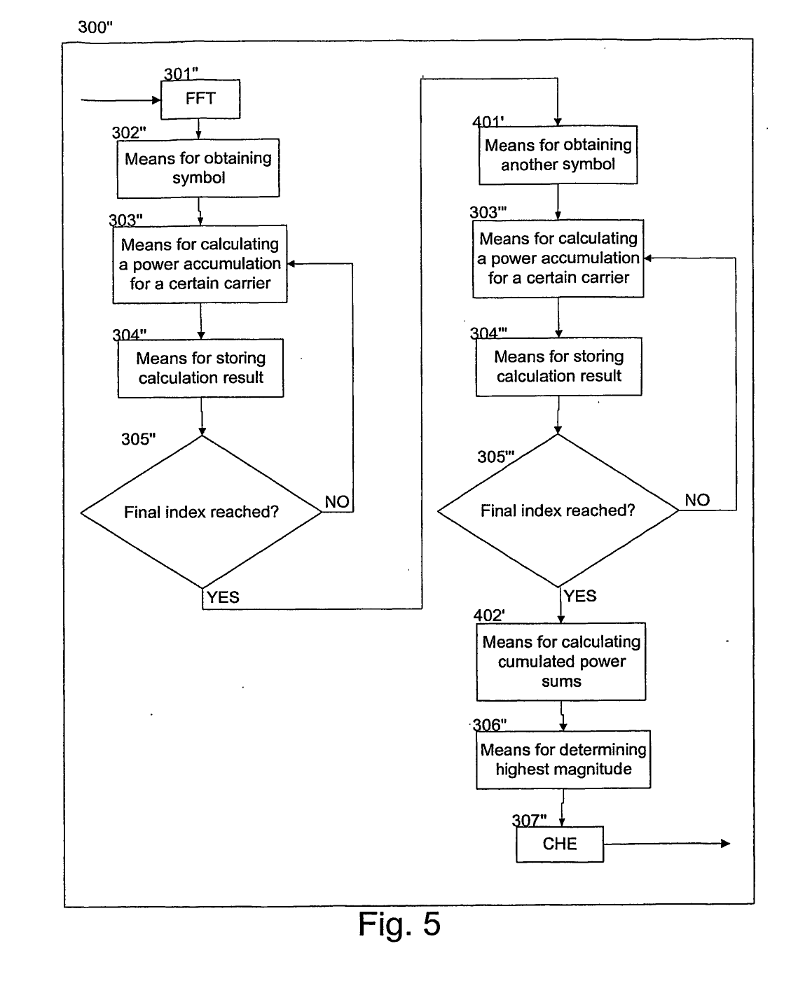

FIG. 5 depicts a partial functional block diagram for a receiver 300″ for a receiving a signal in accordance with still another embodiments of the invention. In FIG. 5 some portions of the receiver 300′ are depicted comprising functional blocks therein, and for the sake of clarity some other parts of the receiver are omitted. Some functional blocks of FIG. 5 may be adapted to perform the corresponding method of the receiver. The receiver 300″ of FIG. 5 can be adapted to perform the functions and means referred to in FIG. 3. The receiver comprises means for receiving a multi-carrier transmission (not shown) and means for performing the FFT for the received signal in the block 301″. The receiver comprises means 302″ for obtaining a symbol such as the OFDM symbol. The receiver comprises also means 401′ for obtaining another symbol. In FIG. 5 the receiver is adapted to first obtain the symbol by the means 302″. The receiver is further adapted to determine the power accumulation sum(s) of the certain carrier(s) for the first symbol in the means 303″, 304″, and 305″. For example, the receiver may determine four power sums for possible scattered pilot raster carrier positions within the symbol. The receiver of FIG. 5 is further adapted to obtain and determine the power accumulation sum(s) of the certain carrier(s) for the another symbol in the means 401′, 303′″, 304′″, and 305′″. For example, the receiver may determine four power sums for possible scattered pilot raster carrier positions within the another symbol.

The receiver of FIG. 5 further comprises means 402′ for calculating cumulated power sums. Thus for, for example, improving robustness, also scattered raster pilots of more than one symbol can be possibly searched and obtained. The cumulated power sum uses a certain power accumulation sum of the first symbol and a certain power accumulation sum of the another symbol. The power accumulation sums for the cumulated power accumulation sum is selected in such a way that the correspondence pattern of the scattered raster pilot carrier positions is utilised. Thus the pilot carriers in different symbols do have a match for indicating a higher power accumulation. For example, the scattered raster pilot carriers are searched for and used based on their typical ‘diagonal’ offset structure.

The receiver of FIG. 5 comprises also means 306″ for determining the highest magnitude maximum from the cumulated power sums. The highest one determines the current scattered raster pilot position. The receiver comprises also the means 307″ for CHE.

Various Power Based Fast Scattered Pilot Synchronizations

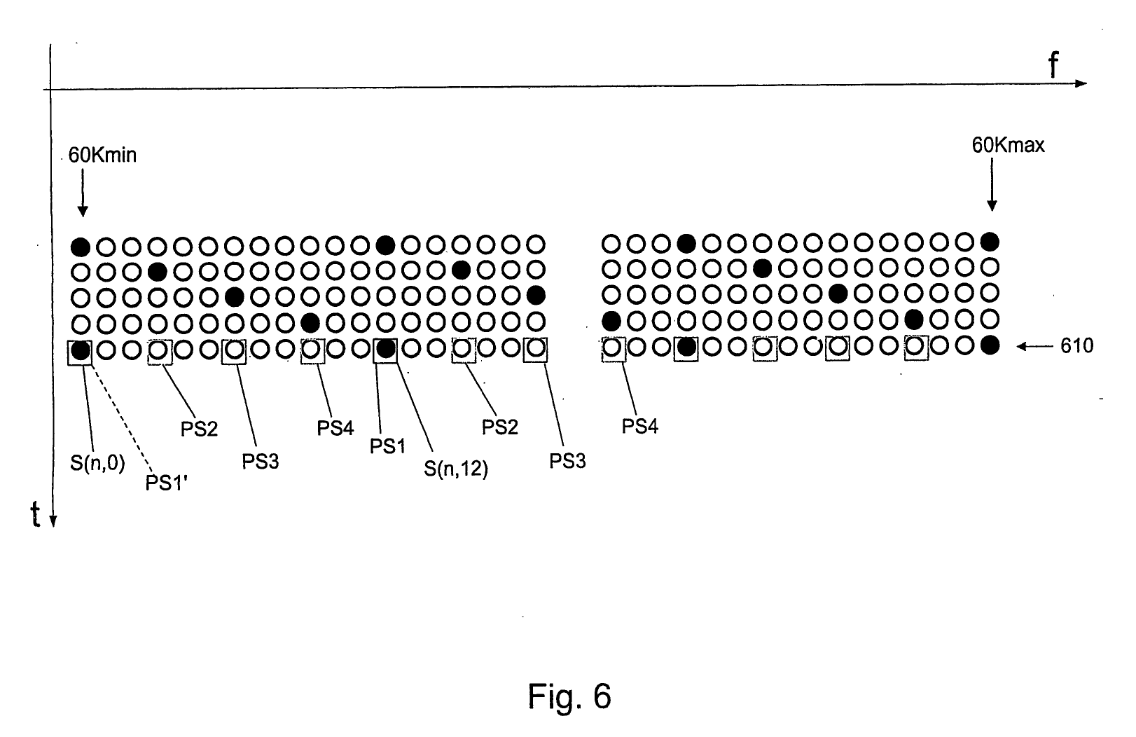

FIG. 6 depicts a schematic example of scattered pilot positions where carrier power sums are adapted to be applied in accordance with some embodiments of the invention. With some embodiments of the invention proposing a fast power based scattered pilot synchronization, the position of the scattered pilots within the OFDM symbol, and thus the two LSBs of the OFDM symbol number, is found within just one OFDM symbols. Since synchronization can only proceed after this position is found, a considerable speed-up is achieved compared to the TPS based solution. For the time-slicing, this is relevant, because the DVB-H time-slicing receiver must prepare for the worst-case delay in order to guarantee synchronization.

Thus in some further embodiments of the invention it is proposed to use a power based fast scattered pilot synchronization to cut down the time needed for scattered pilot synchronization to just one OFDM symbols. The process and the receiver device or any sub-assembly or component of the receiver utilizes the fact, that the scattered pilots are boosted in amplitude by 4/3 compared to data carriers. The position of scattered pilots can be, for example, given in the standard publication “Digital Video Broadcasting (DVB)”, ETSI ETS 300 744, incorporated herein as a reference, as disclosed in the said standard:

For the symbol of index 1 (ranging from 0 to 67), carriers for which index k belongs to the subset {k=Kₘᵢₙ+3×(l mod4)+12p/p integer, p≧0, k ε [Kₘᵢₙ; Kₘₐₓ] are scattered pilots. Where p is an integer that takes all possible values greater than or equal to zero, provided that the resulting value for k does not exceed the valid range [Kₘᵢₙ;Kₘₐₓ]. Kₘᵢₙ is 0, and Kₘₐₓ is 1704 for the 2 k mode, (3408 for the 4 k mode), and 6816 for the 8 k mode.

FIG. 6 illustrates the positions of the scattered pilots (shown as dark spots). The data carriers are depicted as circles in the example. A horizontal axis denotes frequency f. Thus one entire horizontal row depicts a symbol, i.e. a symbol 610. A vertical axis denotes time t. The vertical rows depicts carriers with the same index K. For example, carriers 60 Kmin having index Kₘᵢₙ to carriers (60 Kmax) having index Kₘₐₓ. So the transmission and reception of the symbols is time dependent, and the different carriers in a symbol have different frequencies.

In some DVB standardised examples there are symbols with numbers 0 to 67 (in total 68 symbols). The symbols are indexed with numerical order. So these arrive at different time. In the DVB example, the K-value depend on applicable modes and can be for example in 2 k mode (Kₘᵢₙ=0−Kₘₐₓ=1704), in 4 k mode (Kₘᵢₙ=0−Kₘₐₓ=3408), and in 8 k mode (Kₘᵢₙ=0−Kₘₐₓ=6816).

As shown a pattern is established for the pilot carriers (dark spots) in the example of FIG. 6. This is shown as pilots appear in diagonals in the FIG. 6. Moreover, certain indexes of carriers of different symbols have the similar appearance within their respective symbol.

Some embodiments of the power based fast scattered pilot synchronization utilizes the fact, that the scattered pilots are boosted in amplitude by 4/3 compared to data carriers.

In the example, by sensing all four possible scattered raster pilot positions with a power accumulation, the current location of the scattered pilots can be found.

Still referring to FIG. 6, S(n,c) denotes the c-th subcarrier of the current OFDM symbol (index n) as a complex number. In the FIG. 6, examples S(n,0), and S(n,12) are are shown for depicting some of the following formulas. It should be noted that for the sake of clarity only some positions of power sums PS₁, PS₁′, PS₂, PS₃ and PS₄ (possible pilot carrier positions) according to the formulas are depicted. The other positions can be obtained based on the given formulas running the index p further. The four power sums can be given as:

$${PS}_{1} ( n ) = {\sum }_{p = 0}^{{p}_{max}} S ( n , 12 p + 12 ) \cdot S * ( n , 12 p + 12 )$$

$${PS}_{2} ( n ) = {\sum }_{p = 0}^{{p}_{max}} S ( n , 12 p + 3 ) \cdot S * ( n , 12 p + 3 )$$

$${PS}_{3} ( n ) = {\sum }_{p = 0}^{{p}_{max}} S ( n , 12 p + 6 ) \cdot S * ( n , 12 p + 6 )$$

$${PS}_{4} ( n ) = {\sum }_{p = 0}^{{p}_{max}} S ( n , 12 p + 9 ) \cdot S * ( n , 12 p + 9 )$$

with pₘₐₓ=141 for the 2 k mode, 283 for 4 k mode and 567 for 8 k mode.

With this definition of the power sums, all four take the same number of carriers into account.

Another alternative would be to define PS₁′ as:

$${PS}_{1}^{′} ( n ) = {\sum }_{p = 0}^{{p}_{max}} S ( n , 12 p ) \cdot S * ( n , 12 p )$$

Thus by sensing all four possible raster positions of the scattered pilots, a clear distinct magnitude maximum
PSₘₐₓ(n)=max(PSₚ(n)); p ε {1,2,3,4}
can be found for the current scattered pilot raster position (SPRP)

$$SPRP ( n ) = arg {max}_{p} ( {PS}_{p} ( n ) ) ;$$

$$p ∈ \{ 1 , 2 , 3 , 4 \} .$$

The SPRP can distinguishably indicate the position of the pilot, thereby enabling a symbol to be recognized. Thus, the one giving the highest magnitude determines the current scattered raster pilot position.

The examples of the formulas PS₁, PS₂, PS₃, PS₄ and PS₁′ can produce numerical real values. However, in some further embodiments complex and/or the numerical values can be applied, i.e. the values can represent absolute values of i/q-parameters.

The indexes in the formulas can be adopted to correspond with the scattered raster pilot positions of the applied pattern. Thus the FIG. 6 depicts an example only and do not limit the invention to the specific pattern of FIG. 6. Also the pilot positioning can be such that the certain same carrier indexes in the symbol may not necessary correspond, thus have the boosted power, but i.e. carrier indexes having certain other repetition patter in the symbol correspond. All that this would require, is the predetermined regular known pattern for scattered raster pilot positions that the formulas can be adopted to the predetermined regular known pattern in question.

In the depicted example of FIG. 6, the power accumulation sum(s) PS₁ and PS₁′ have the maximum. Accordingly, a certain symbol can be deduced to be the currently received symbol based on this highlighting.

The time needed for some embodiments of the fast power based scattered pilot synchronization can be only one OFDM symbol. Compared to standard TPS synchronization, this is a considerable improvement.

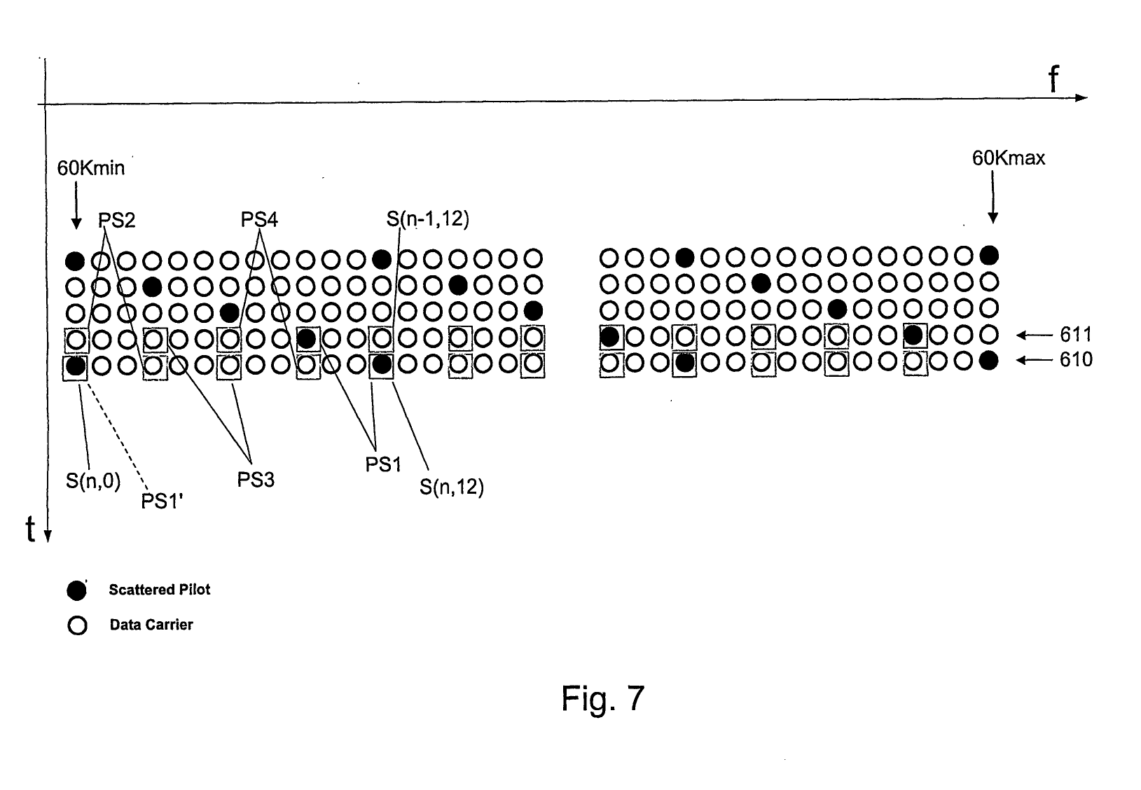

FIG. 7 depicts an example of scattered pilot positions where cumulated carrier power sums (CPSs) are adapted to be applied in accordance with some embodiments of the invention. The example of FIG. 7 is based on the similar principles than in the FIG. 6. In addition to FIG. 6, in the FIG. 7 the marked carriers depict the cumulated power sums (CPSs). It should be noted that for the sake of clarity only some positions of possible pilot carrier positions according to the formulas are depicted. The example of FIG. 7 can provide more robustness against the noise, and make the process and the receiver more reliable. For improving the noise robustness, also the scattered pilots of more than one OFDM symbols can be searched and used. For example two consecutive OFDM symbols can be applied as follows, wherein PS(n−1) denotes the neighbouring symbol which can also be referred to as the another symbol.
CPS₁(n)=PS₁(n)+PS₄(n−1)
CPS₂(n)=PS₂(n)+PS₁(n−1)
CPS₃(n)=PS₃(n)+PS₂(n−1)
CPS₄(n)=PS₄(n)+PS₃(n−1)

The scattered pilots are searched for in their ‘typical’ diagonal offset structure. The example of FIG. 7 can be extended to take more OFDM symbols into account.

Thus the CPS giving the maximum shows the current SPRP and indicates the symbol in question.

Various Further Implementations

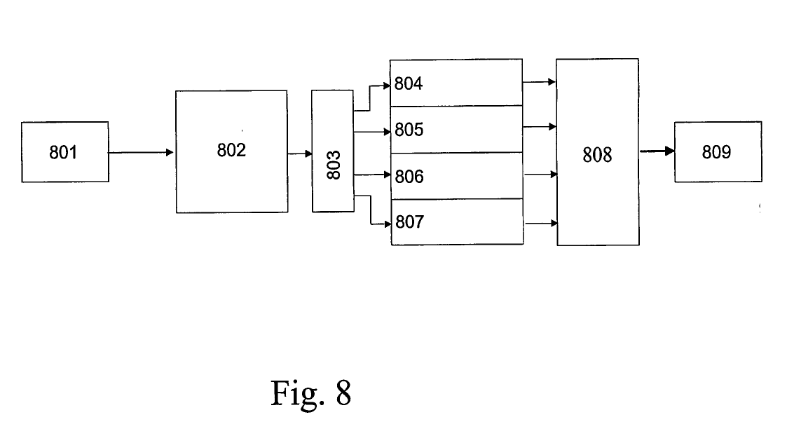

FIG. 8 depicts a partial functional block diagram of a receiver for receiving a transmission in accordance with some embodiments of the invention. Thus having knowledge of the symbol number, also the position of the scattered pilots can be known, and this can be one goal of the receiver and operations. A decision block 808 is meant to do the maximum search. Some embodiments of the receiver can be adapted to carry out the means and process of the example of FIGS. 3-7. The receiver comprises a FFT block 801 for performing the FFT for the received multi-carrier signal such as the OFDM signal. The FFT block 801 or the like is coupled with a power accumulation sum block 802. A symbol is obtained and received by the FFT 801. The power accumulation sum block 802 is adapted to calculate the power accumulation sum for certain carriers of the symbol. The carriers for the power sum are selected in such a way that possible pilot carrier positions are selected. The power accumulation sum block 802 is coupled with accumulators 1 to 4 having reference numbers respectively 804 to 807 via the demultiplexer 803. The accumulators 804 to 807 are adapted to store the respective power accumulation sum calculation results, e.g. power sum PS₁ can reside in the accumulator 1 804.

Still referring to the FIG. 8, the decision block 808 is adapted to test the power sum results of the accumulators 804 to 807. Control logic for ending the accumulating of the power sums is omitted in the FIG. 8 for simplicity reasons. It should be noted that the number of the power sums and the respective accumulator are not limited to four as in the example.

Still referring to the FIG. 8, the decision block 808 can calculate or find a power accumulation magnitude maximum for the calculated power accumulations sum. A distinguishable power accumulation magnitude maximum is found for the power accumulation sum indicating the pilot carriers indexes because the scattered pilots are boosted with higher amplitude than the data carriers.

Thus by sensing possible raster positions of the scattered pilots, a distinguishable power accumulation magnitude maximum is found for the current scattered pilot raster position.

Still referring to the FIG. 8, the decision block can be coupled with the channel estimation CHE 809.

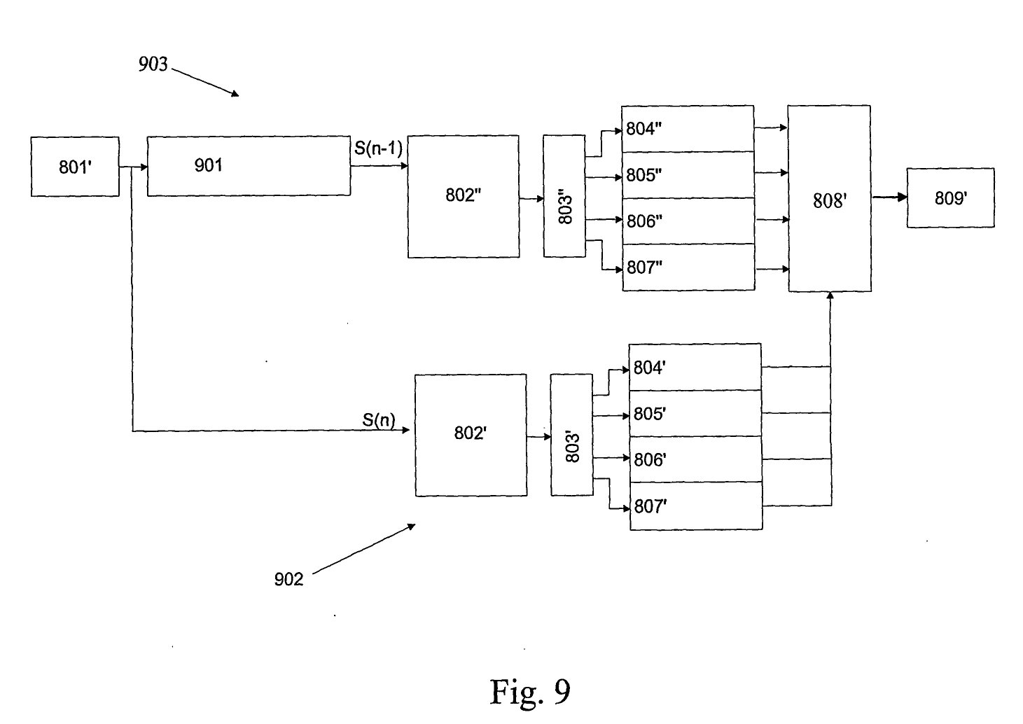

FIG. 9 depicts a partial functional block diagram of a receiver for receiving a transmission in accordance with cumulated power sum embodiments of the invention. The example of FIG. 9 depicts some of the cumulated power sum embodiments. The receiver comprises two branches, one for symbol S(n) 902 and the other for the another symbol S(n-1) 903. The branch 902 can be equivalent to the one of FIG. 8 or the like. In the branch 903 the FFT block 801′ or the like is coupled with a delay block 901. The FFT block 901 is coupled with a power sum 802″. A symbol is obtained and received by the FFT 801′. The delay block 901 can be adapted to delay the received symbol to some extent in time dependent way. The received symbol can be delayed to certain another symbol. The delay block 901 may then obtain the another symbol such as the consecutive symbol or the like.

Referring to the example of FIG. 9, the branches 902 and 903 can operate similarly with the another symbol as the one depicted referring to FIG. 8. It should be noted that the number of the summed carriers and the respective accumulators are not limited to four as in the example. The number carriers and symbols correspondences in such a way that a certain predetermined known correspondence patter is established for pilot carriers (positions) in a matrix comprising carriers of these two symbols.

Still referring to the FIG. 9, the decision block 808′ can calculate the cumulated power sum based on the S(n) branch 902 and the S(n-1) branch 903. Moreover, the decision block 808′ can find a cumulated power accumulation magnitude maximum for the calculated cumulated power sums. A quite robust distinguishable cumulated power accumulation magnitude maximum is found for the cumulated power sums indicating the pilot carriers (positions) because the scattered pilots are boosted with the higher amplitude than the data carriers.

Thus by sensing all possible scattered raster pilot positions with a power accumulation, the current location of the scattered pilots can be found.

Still referring to the FIG. 9, the decision block can be coupled with the channel estimation block (CHE) 809′.

There are various embodiments for calculating the cumulated power sums (CPSs). For example, FIG. 8 can be applied such that the demultiplexer 803 of FIG. 8 is intelligently controlled to add, for example, PS₁(n−1) to the same accumulator as PS₁(n). As the symbols are anyhow coming from FFT in sequential order (e.g. after symbol n−1, symbol n is coming), no dedicated delay block 901 is necessarily needed.

Some embodiments may relate to a DVB-T derived standard, called DVB-H (DVB handheld) which has awoken great deal of interest, and it will most probably support, among others, the feature of time-slicing. This will be the key enabler to support DVB-H in small and portable devices, such as mobile phones.

The complexity needed for implementing various embodiments of the synchronization technique is fairly low, since most of the required computational resources are anyhow available from post-FFT acquisition. Of course, the post FFT-acquisition computational resources are not only mandatory implementations. For example, a more specific design can be applied as well, or other used circuitry of the receiver applied.

Embodiments of the invention can be implemented in many DVB-T/DVB-H receiver. In some embodiments of the invention this can be done by an ASIC for example. Thus a chipset for receiver the multi-carrier transmission in accordance with the embodiments may be one or more ASIC.

In still some of the various embodiments, the block, which will include the scattered pilot synchronization, can be a buffer block (BUF) of the receiver. This buffer block can be used to store the data carriers and scattered pilot carriers of several OFDM symbols in order to allow channel estimation (CHE) to span over several OFDM symbols.

Therefore, at the output of the FFT, there is a demultiplexer that splits the carriers into data carriers, continual pilot carriers, scattered pilot carriers, and possibly TPS carriers. In order to do so, the position of the scattered pilots (the carrier indices of these) has to be known. Position of all the others is constant.

As referred to in the prior art, the traditional way was to use the TPS synchronization that, besides others, determines the OFDM symbol number within an OFDM frame. So this manner of operation may be replaced by the embodiments of the invention.

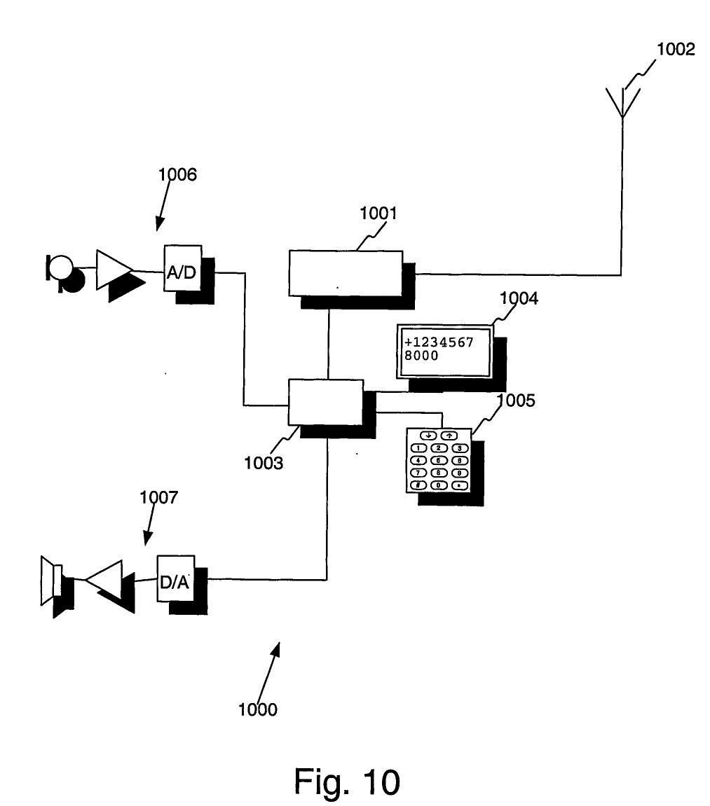

An example of FIG. 10 depicts a more general functional block diagram of the receiver. The illustrated receiver 1000 may be used in any or all of the various embodiments. The receiver comprises a processing unit 1003, a multi-carrier signal receiver part 1001 such as OFDM signal receiver and a user interface (UI). The user interface comprises a display 1004 and a keyboard 1005. In addition, the UI comprises an audio input 1006, and audio output 1007. The processing unit 1003 comprises a microprocessor (not shown), possibly a memory (not shown) and software (not shown). The processing unit 1003 controls, on the basis of the software, the operations of the receiver 1000, such as receiving a signal, receiving the data stream, receiving of a symbol, possibly receiving another symbol, establishing power accumulation sums of the possible scattered pilot carriers of the symbol(s), comparing the power accumulation results, determining the position of the scattered raster pilot position, calculating the symbol in question. Various operations and means are described in the examples of FIGS. 3-9.

Referring to the FIG. 10, alternatively, middleware or software implementation can be applied (not shown). The receiver 1000 can be a hand-held device or a mobile device which the user can comfortable carry. Advantageously, the receiver 1000 can be a mobile phone which comprises the multi-carrier signal receiver part 1001 such as the OFDM receiver for receiving OFDM signal. The receiver may interact with the service providers.

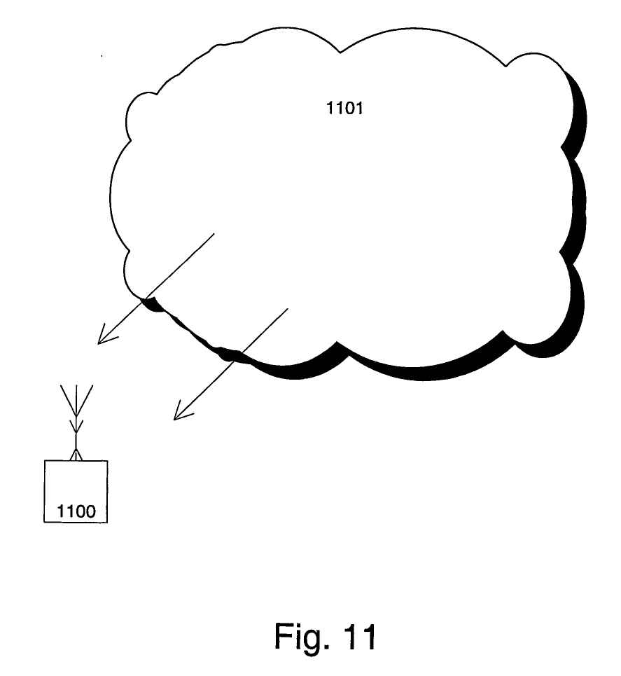

Various embodiments of the invention can be applied in the system of FIG. 11. The receiver 1100 operates preferably under coverage of a digital broadcast network (DBN) 1101 applying e.g. OFDM radio signal based transmission. The receiver is capable of receiving the transmission the DBN is providing and receives the OFDM based signal. Operations of the receiver can be receiving a signal, receiving the data stream, receiving of a symbol, possibly receiving another symbol, for example, by delaying the reception, power accumulation summing the carriers of symbol(s), comparing the results, determining the position of the scattered raster pilot position, determining the symbol in question. Various operations and means are described in the examples of FIGS. 3-9.

Ramification and Scope

While there has been described what are believed to be the preferred embodiments of the present invention, those skilled in the art will recognise that other and further changes and modifications may be made thereto without departing from the spirit of the invention, and it is intended to claim all such changes and modifications as fall within the true scope of the invention.

1. A receiver for receiving a multi-carrier transmission, wherein the multi-carrier transmission comprises various symbols, each symbol comprising a plurality of carriers, the receiver comprising:
means for accessing at least one symbol which is adapted to establish a distinguishable power based pattern for pilot carriers in the at least one symbol,
means for establishing power accumulation sums for possible pilot carriers of the symbol based on the pattern, and
means for determining a power accumulation sum maximum of the sums indicating a pilot carrier position.

2. A receiver according to claim 1, wherein one of the possible pilot carriers is adapted to comprise the maximum in accordance with the predetermined pattern for the pilot carriers within the symbol.

3. A receiver according to claim 1, wherein the position of the possible pilot carriers is adapted to be based on the pattern in such a way that carrier indexes having a pilot in a matrix of certain number of symbols are adapted to be selected, and the corresponding carrier index position within the accessed symbol is accordingly adapted to be selected.

4. A receiver according to claim 1, wherein every predetermined carrier of the symbol is adapted to be selected for the means for establishing the power accumulation sums.

5. A receiver according to claim 4, wherein every fourth carrier of the symbol is adapted to be selected for the means for establishing the power accumulation sums.

6. A receiver according to claim 1, wherein the distinguishable power based pattern comprises boosted pilot carriers compared to data carriers of the symbol.

7. A receiver according to claim 6, wherein the pilots are boosted in amplitude of 4/3 compared to the data carriers.

8. A receiver according to claim 1, wherein the means for establishing power accumulation sums comprises:
means for performing a first power accumulation sum for first possible pilot carrier positions of the symbol,
means for performing a second power accumulation sum for second possible pilot carrier positions of the symbol,
means for performing a third power accumulation sum for third possible pilot carrier positions of the symbol,
means for performing a fourth power accumulation sum for fourth possible pilot carrier positions of the symbol, and
the means for determining comprises:
means for detecting the power accumulation maximum magnitude from the first, second, third, and fourth power accumulation sums for indicating the current scattered pilot raster position.

9. A receiver according to claim 8, wherein the first power accumulation sum is adapted to be calculated based on the following formulae:
$${PS}_{1} ( n ) = {\sum }_{p = 0}^{{p}_{max}} S ( n , 12 p + 12 ) \cdot S * ( n , 12 p + 12 )$$
wherein S(n,c) denotes c-th subcarrier of the current symbol and pₘₐₓ depends on the used mode of the transmission.

10. A receiver according to claim 8, wherein the second power accumulation sum is adapted to be calculated based on the following formulae:
$${PS}_{2} ( n ) = {\sum }_{p = 0}^{{p}_{max}} S ( n , 12 p + 3 ) \cdot S * ( n , 12 p + 3 )$$
wherein S(n,c) denotes c-th subcarrier of the current symbol and pₘₐₓ depends on the used mode of the transmission.

11. A receiver according to claim 8, wherein the third power accumulation sum is adapted to be calculated based on the following formulae:
$${PS}_{3} ( n ) = {\sum }_{p = 0}^{{p}_{max}} S ( n , 12 p + 6 ) \cdot S * ( n , 12 p + 6 )$$
wherein S(n,c) denotes c-th subcarrier of the current symbol and pₘₐₓ depends on the used mode of the transmission.

12. A receiver according to claim 8, wherein the fourth power accumulation sum is adapted to be calculated based on the following formulae:
$${PS}_{4} ( n ) = {\sum }_{p = 0}^{{p}_{max}} S ( n , 12 p + 9 ) \cdot S * ( n , 12 p + 9 )$$
wherein S(n,c) denotes c-th subcarrier of the current symbol and pₘₐₓ depends on the used mode of the transmission.

13. A receiver according to claim 8, wherein the first power accumulation sum is adapted to be calculated based on the following formulae:
$${PS}_{1}^{′} ( n ) = {\sum }_{p = 0}^{{p}_{max}} S ( n , 12 p ) \cdot S * ( n , 12 p ) ,$$
wherein S(n,c) denotes c-th subcarrier of the current symbol and pₘₐₓ depends on the used mode of the transmission.

14. A receiver according to claim 8, wherein in the means for detecting the power accumulation maximum magnitude is adapted to be based on the following formulae:
PSₘₐₓ(n)=max(PSₚ(n)); p ε {1,2,3,4}, wherein PSₚ(n) denotes the first, second, third, and fourth power accumulation sums, p is adapted to determine pilot carrier positions for identifying a certain symbol, and
the current scattered pilot raster position (SPRP) is adapted to be found based on the following formulae:
$$SPRP ( n ) = arg {max}_{p} ( {PS}_{p} ( n ) ) ;$$
$$p ∈ \{ 1 , 2 , 3 , 4 \} ,$$
wherein the PSₚ(n) denotes the first, second, third, and fourth power accumulation sums, p is adapted to determine pilot carrier positions for identifying a certain symbol.

15. A receiver according to claim 1, wherein the means for accessing comprises:
means for obtaining a first symbol of the transmission,
means for obtaining another symbol in relation to the first symbol.

16. A receiver according to claim 15, wherein the accessed symbols comprise currently received symbol and certain predetermined another symbol preceding or following the currently received symbol.

17. A receiver according to claim 15, wherein the accessed symbols comprise currently received symbol and certain predetermined another symbol preceding or following the currently received symbol so that the correspondence pattern is adapted to be established between pilot carriers of the symbols for possible carrier positions within the matrix of the symbols.

18. A receiver according to claim 15, wherein the certain predetermined another symbol comprises a consecutive symbol preceding or following the currently received symbol.

19. A receiver according to claim 15, wherein the means for establishing power accumulation sums comprises:
means for establishing power accumulation sums for possible pilot carriers of the first symbol, and the receiver further comprises:
means for establishing another power accumulation sums for possible pilot carriers of the another symbol, and
means for establishing cumulated power sums from the power accumulation sums and the another power accumulated sums,
and the means for determining the power accumulation sum maximum comprises:
means for determining the power accumulation sum maximum of the cumulated power sums for indicating the current pilot carrier position.

20. A receiver according to claim 19, wherein the means for establishing another power accumulation sums comprises:
means for performing a first another power accumulation sum for first possible pilot carrier positions of the another symbol,
means for performing a second another power accumulation sum for second possible pilot carrier positions of the another symbol,
means for performing a third another power accumulation sum for third possible pilot carrier positions of the another symbol,
means for performing a fourth another power accumulation sum for fourth possible pilot carrier positions of the another symbol.

21. A receiver according to claim 19, wherein for the means for establishing cumulated power sums from the power accumulation sums and another power accumulation sums, the respective power accumulation sums of the first and the another symbol are adapted to be selected in such a way that the pilot carriers of the symbols have a correspondence for the respective sums.

22. A receiver according to claim 20, wherein means for establishing cumulated power sums from the power accumulation sums and the another power accumulated sums comprises:
means for performing a first cumulated power sum for the first power accumulation sum of the first symbol and the fourth another power accumulation sum of the another symbol,
means for performing a second cumulated power sum for the second power accumulation sum of the first symbol and the first another power accumulation sum of the another symbol,
means for performing a third cumulated power sum for the third power accumulation sum of the first symbol and the second another power accumulation sum of the another symbol, and
means for performing a fourth cumulated power sum for the fourth power accumulation sum of the first symbol and the third another power accumulation sum of the another symbol.

23. A receiver according to claim 1, wherein the multi-carrier transmission comprises OFDM transmission using time slicing, the symbol comprises OFDM symbol and the plurality of carriers comprise data carriers and scattered pilot carriers.

24. A receiver according to claim 1, wherein the multi-carrier transmission comprises time slicing based power saving based on bursts, and a synchronization of the receiver into the bursts is adapted to be based on the indicated pilot position for finding index of the received symbol.

25. A receiver according to claim 1, wherein the multi-carrier transmission comprises DVB transmission using time slicing based on bursts, and synchronization into the bursts is adapted to be based on the indicated pilot position for finding an indication indicating the OFDM symbol.

26. A receiver according to claim 1, wherein the receiver further comprises:
a Fast Fourier Transform (FFT) means for FFT transformation of the received transmission for obtaining the symbol,
accumulator means for accumulating power accumulation sum results, and
Channel Estimation means (CHE) for further continuing the reception of the transmission.

27. A receiver according to claim 1, wherein computational resources for performing the operations of at least one of the means comprises the same computational resources which are adapted to perform a post-FFT acquisition in the receiver.

28. A receiver according to claim 1, wherein a buffer means of the receiver is adapted to contain all said means.

29. A mobile terminal for receiving a multi-carrier transmission, wherein the multi-carrier transmission comprises various symbols, each symbol comprising a plurality of carriers, the terminal comprising:
means for accessing at least one symbol which is adapted to establish a distinguishable power based pattern for pilot carriers in the at least one symbol,
means for establishing power accumulation sums for possible pilot carriers of the symbol based on the pattern, and
means for determining a power accumulation sum maximum of the sums indicating a pilot carrier position.

30. A sub-assembly of a terminal for receiving a multi-carrier transmission, wherein the multi-carrier transmission comprises various symbols, each symbol comprising a plurality of carriers, the sub-assembly comprising:
means for accessing at least one symbol which is adapted to establish a distinguishable power based pattern for pilot carriers in the at least one symbol,
means for establishing power accumulation sums for possible pilot carriers of the symbol based on the patter, and
means for determining a power accumulation sum maximum of the sums indicating a pilot carrier position.

31. A chipset for receiving a multi-carrier transmission, wherein the multi-carrier transmission comprises various symbols, each symbol comprising a plurality of carriers, the chipset comprising:
means for accessing at least one symbol which is adapted to establish a distinguishable power based pattern for pilot carriers in the at least one symbol,
means for establishing power accumulation sums for possible pilot carriers of the symbol based on the pattern, and
means for determining a power accumulation sum maximum of the sums indicating a pilot carrier position.

32. A method for receiving a multi-carrier transmission, wherein the multi-carrier transmission comprises various symbols, each symbol comprising a plurality of carriers, the method having the steps of:
accessing at least one symbol which is adapted to establish a distinguishable power based pattern for pilot carriers in the at least one symbol,
establishing power accumulation sums for possible pilot carriers of the symbol based on the pattern, and
determining a power accumulation sum maximum of the sums indicating a pilot carrier position.

33. A computer program comprising computer program code means adapted to perform the steps of claim 32 when said program is run on a computer.

34. A computer program product as claimed in claim 33 embodied on a computer readable medium.
